(19) United States
(12) Patent Application Publication
(10) Pub. No.: US 2005/0279581 A1
(43) Pub. Date: Dec. 22, 2005

(54) Single-column, movable side mini-lift for moving automotive vehicles

(75) Inventor: Cristian P. Koch, Alhaurin El Grande (Malaga) (ES)

Correspondence Address: KRAMER & AMADO, P.C., Suite 240, 1725 Duke Street, Alexandria, VA, 22314, US

(73) Assignee: IKOTEC MORRISON, S.L., Alhaurin El Grande (Malaga) (ES)

(21) Appl. No.: 11/053,412

(22) Filed: Feb. 9, 2005

(30) Foreign Application Priority Data
Jun. 4, 2004 (EP) 04380122.4

(51) Int. Cl. B66F 9/06

(52) U.S. Cl. 187/222

(57) ABSTRACT

The single-column, movable side mini-lift for moving automotive vehicles is made up of a column (1), arranged vertically on a base (2) having two front legs provided with fixed wheels (16) and a rear part provided with a movable wheel (17), inside of which column there is a forcing screw (7), guided by means of a bearing (15) located in the upper part of the column (1) containing a lifting carriage (4), made up of a structure provided with four bearings (5) and a lifting nut (6) synchronous with the screw (7), and a hook (3) fixed thereto, fixed to which hook are the bearing bases for fixing to the vehicle and achieving lifting thereof in order to carry out different mechanical operations.

### OBJECT OF THE INVENTION

The present specification refers to an application for a Utility Model corresponding to a single-column, movable side mini-lift for moving automotive vehicles, the evident purpose of which lies in being configured as a lift having the function of tilting an automobile sideways, the latter being placed in an ergonometric position suitable for carrying out different mechanical repair tasks thereon, as well as bodywork and painting, different from the positions achieved with the currently available equipment.

### FIELD OF THE INVENTION

This invention has its application within the industry dedicated to the manufacture of lifts for automotive vehicles, and more specifically within the industry dedicated to the manufacture of equipment intended for being used by vehicle repair shops dedicated to the repair of automotive vehicles, regardless of whether carrying out repair of the mechanism incorporated in the vehicles or bodywork repair and painting thereof are involved.

### BACKGROUND OF THE INVENTION

The applicant is aware that within the lifting equipment, specifically for automobiles, there are several models and elements intended for being used by repair services, such as:

The type for complete lifting and to a usual height of about two meters, among which basic designs are found which are made up of two columns, four columns or double scissor.

The type for complete lifting, which achieve lifting the automotive vehicle only to a height of about one meter, pantographic-type or simple scissor designs existing.

The type for partial lifting, called hydraulic jacks, among which there is a wide range of sizes and models.

The applicant is also aware of the use of a jack which placed the automobile in a side position at 90°, but which was not successfully marketed, due to the complexity thereof in its practical use.

The evident solution to these drawbacks would be that of being able to have a lift with reduced dimensions, which would allow for tilting the automobile in a sideways position.

However, the applicant is not at all aware of the current existence of an invention provided with the features described in the present specification.

### DESCRIPTION OF THE INVENTION

The single-column, movable side mini-lift for moving automotive vehicles proposed by the invention has in its context all the features required of the invention in question, and a practical application.

More specifically, the single-column, movable side mini-lift for moving automotive vehicles object of the invention is constituted of a vertical column arranged on a movable base, and in the column there is a screw containing a lifting carriage and a hook fixed thereto, fixed to which hook are several bearing bases applicable for being fixed to the vehicle, i.e. wheel-bearing base or a frame flange-bearing base.

The equipment in question can be transferred to the area or point where the automotive vehicle is parked or located, and in this case, when it is applied towards the wheel-bearing base, the equipment is positioned, taking it up by the front wheel on the side which is to be lifted, actuating the control towards the lift position, whereby the motor and the screw start turning and in this moment the lifting carriage starts lifting the vehicle upwards in the vertical direction.

Since the vehicle is taken up by its side wheel, it will start to be lifted sideways, the end lift position being defined by the operator, according to his or her necessities, a maximum height being determined by the end of stroke of the lifting screw, about one meter.

The vehicle will be supported on the two wheels of the side opposite to the wheel taken up by the equipment, and the other side will be supported by the equipment made up of the mini-lift, and in this working position, relevant repair operations will be carried out, allowing for the simplified inspection in the lower areas of the vehicle or repair of the bodywork and painting.

The invention also allows for the change of the fuel filter, repair of the exhaust pipes, search for fluid leaks, etc.

On the other hand, the invention is prepared to be used as a frame flange-bearing base, carrying out the lifting of the vehicle, the latter being in a position in which the inspection of the two wheels of the lifted side accessible so that any task can be carried out thereon.

If the lifting of the automotive vehicle is carried out from one of the rear wheels, lifting of the rear part of the vehicle as well as avoiding the latter from tilting sideways, will be achieved.

### DESCRIPTION OF THE DRAWINGS

To complement the description being made and for the purpose of helping to better understand the features of the invention, a set of drawings is attached to the present specification as an integral part thereof, in which the following has been shown in an illustrative and non-limiting manner:

FIG. 1 shows a general view of the object of the invention corresponding to a single-column, movable side mini-lift for moving automotive vehicles.

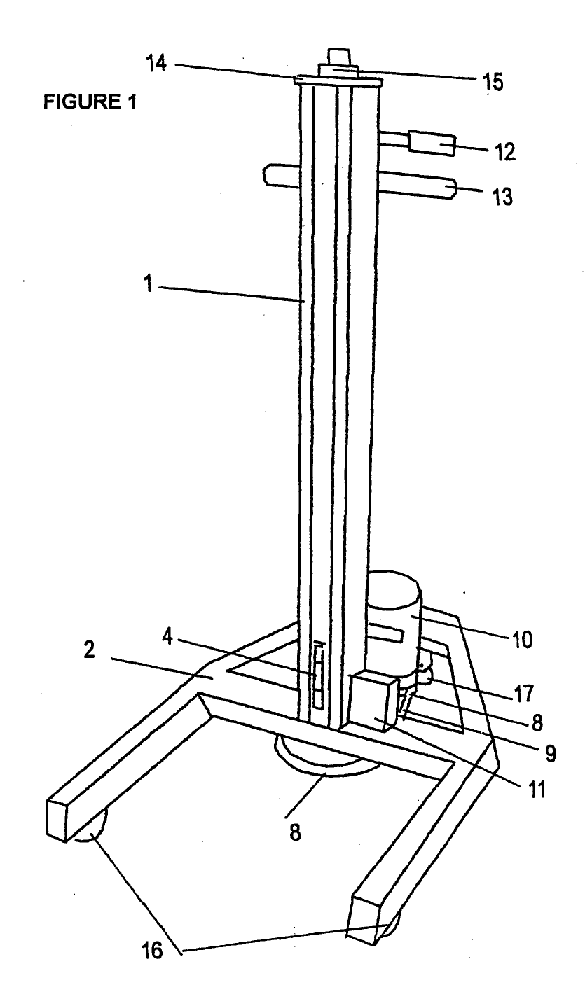

FIG. 2 shows a section of the invention shown in FIG. 1 though the central area.

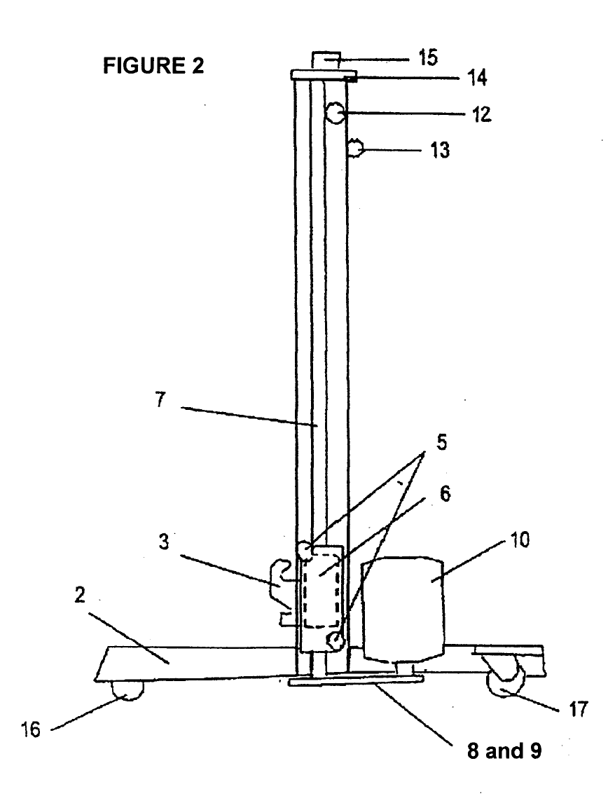

FIG. 3 shows the wheel-bearing base used.

FIG. 4 finally shows the frame flange-bearing base.

### PREFERRED EMBODIMENT OF THE INVENTION

In view of these figures, it can be observed how the single-column, movable side mini-lift for moving automotive vehicles is constituted of a column (1) configured as a specific design support structure vertically placed on the base (2), which is made up of two front legs, each of them containing or incorporating fixed wheels (16), and a rear part with a movable wheel (17).

A forcing screw (7) is internally housed inside the column (1), parallel thereto, containing or incorporating a lifting carriage (4) provided with a hook (3).

The column (1) is complemented with an upper cover (14) containing a conical bearing (15) intended for guiding the forcing screw (7) and in turn supporting the weight resulting from the lifting; the lifting carriage is formed by a structure, four bearings (5) intended for supporting the lifted weight and in turn allowing for displacement thereof, as well as by a lifting nut (6) synchronous with the forcing screw (7) and which will generate the upward or downward movement of the supported vehicle, depending on the direction of rotation carried out on the drive screw, pushing the carriage in the same direction.

The drive screw is actuated through a pulley (8) and belt (9) assembly by means of an electric motor (10) controlled by a reversing switch (11), and this reversing control (11) is controlled by a lever (12) connected to a plurality of rods limiting the upper and lower ends of stroke necessary for a simplified use of this type of tool.

A pair of handles (13) is arranged on the column, by means of which the equipment can be carried in a simplified manner.

This lifting element (4) is implemented with a hook (3) to which several accessories described below are fixed. Namely:

Wheel-bearing base (18) having a suitable support adopting a “U” shape taking up the wheel of the automobile, specifically the one corresponding to the motor in general, and preferably one of the front wheels, and which, with the actuation of the invention, will achieve lifting the vehicle sideways, and if this area of the equipment is placed on the other wheel, specifically the one not corresponding to the one moved by the motor of the automotive vehicle, such as the rear wheel, it will suitably lift the rear part of the vehicle.

Frame flange-bearing base (19) incorporating a “V”-type construction support, which takes up the automobile by the frame flange, and, by actuating the equipment, lifts the automobile sideways.

More specifically, the movable side mini-lift is formed by a suitably designed column (1) arranged vertically on the base (2) made up of two front legs, each one provided with fixed wheels (16), and a rear part provided with a movable wheel (17), the column (1) having a screw (7) located inside of it and positioned parallel to the column (1), containing a lifting carriage (4) provided with a hook (3) implemented with an upper cover (14) with a bearing (15) intended for guiding the screw (7).

The lifting carriage (4) is configured by means of a structure provided with four bearings (5) and a lifting nut (6) synchronous with the previously mentioned forcing screw (7).

The drive screw is actuated by means of a pulley (8) and belt (9) assembly, in addition to the use of an electric motor (10) actuated by a reversing control switch (11).

This reversing switch or control (11) is controlled by a lever (12), and there are two handles (13) on the column (1) for moving the mini-lift, the lifting carriage (4) being implemented with said hook (3) to which the wheel-bearing base (18) and the frame flange-bearing base (19) are fixed.

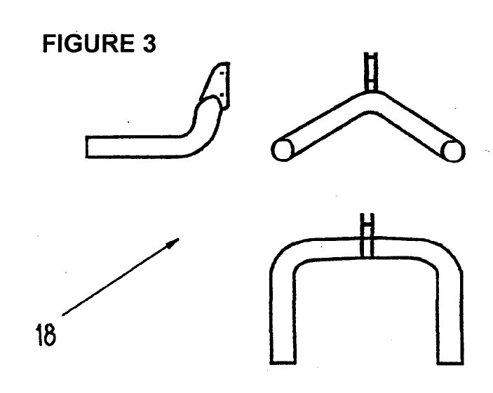

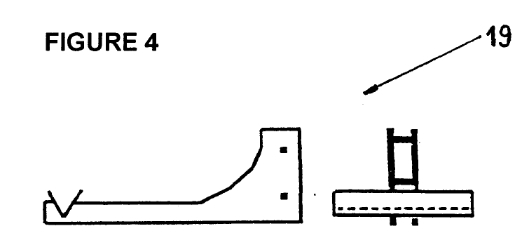

As has been previously stated, the wheel-bearing base (18) has a structure adopting a “U” shape and a support attached to the lifting carriage by the hook (3), as can be observed in FIG. 3, whereas the frame flange-bearing base (19) is provided with a structure adopting a “V” shape and a support attached to the lifting carriage (4) by means of the hook (3), as can be observed in FIG. 4.

1.- A single-column, movable side mini-lift for moving automotive vehicles, of those intended for being used for the mechanical repair of the vehicle to be moved, or for being used in bodywork repair and painting operations, characterized by being constituted of a column (1) arranged in a vertical direction on a base (2), the column (1) being made up of two front legs, provided with fixed wheels (16) and having a rear part provided with a movable wheel (17), a forcing screw (7) being incorporated inside the column (1), parallel thereto, equipped with a lifting carriage (4) provided with a hook (3), completed with an upper cover (14) provided with a bearing (15) which guides the screw (7), the lifting carriage being formed by a structure provided with four bearings (5) and a lifting nut (6) synchronous with the forcing screw (7), the drive screw being operated through a pulley (8) and belt (9) assembly by means of an electric motor (10) controlled by a reversing switch (11), controlled by a lever (12), and two handles (13) being arranged on the column (1), and the lifting carriage (4) being complemented with a hook (3) to which a bearing base (18) and a frame flange-bearing base (19) are fixed.

2.- A single-column, movable side mini-lift for moving automotive vehicles according to the first claim, characterized in that the wheel-bearing base (18) is provided with a structure adopting a “U” shape and a support intended for attaching to the lifting carriage by means of the hook (3).

3.- A single-column, movable side mini-lift for moving automotive vehicles according to the first claim, characterized in that the frame wheel-bearing base (19) is provided with a structure adopting a “V” shape and a support for the attachment to the lifting carriage by means of the hook (3).
